(19) United States
(12) Patent Application Publication
(10) Pub. No.: US 2022/0045368 A1
(43) Pub. Date: Feb. 10, 2022

(54) RECHARGEABLE BATTERY WITH AQUEOUS-BASED ELECTROLYTE

(71) Applicant: Nano and Advanced Materials Institute Limited, Hong Kong (HK)

(72) Inventors: Soon Yee LIEW, Hong Kong (HK); Li FU, Hong Kong (HK); Kevin TAN, Hong Kong (HK)

(21) Appl. No.: 17/389,327

(22) Filed: Jul. 29, 2021

Related U.S. Application Data
(60) Provisional application No. 63/061,192, filed on Aug. 5, 2020.

(51) Int. Cl. H01M 10/36; H01M 4/38; H01M 4/50; H01M 50/411

(52) U.S. Cl. CPC H01M 10/36; H01M 4/38; H01M 2300/0085; H01M 50/411; H01M 2300/0002; H01M 4/50

(57) ABSTRACT

The present invention provides a rechargeable lithium metal oxide-zinc battery system with an aqueous-based electrolyte including at least one positive electrode including a lithium compound, at least one negative electrode including zinc or a zinc compound, an aqueous-based electrolyte and an aqueous-based solvent. The aqueous-based electrolyte includes at least one zinc-based electroactive material and at least one lithium-based electroactive material. The combination of the electrodes and electrolyte composition suppresses electrode corrosion and gas generation at the negative electrode.

### CROSS-REFERENCE TO RELATED APPLICATION

The present application claims the priority from the U.S. provisional patent application Ser. No. 63/061,192 filed Aug. 5, 2020, and the disclosure of which is incorporated herein by reference in its entirety.

### BACKGROUND

### Technical Field

The present invention relates to a rechargeable lithium metal oxide-zinc battery system. In particularly, the rechargeable lithium metal oxide-zinc battery includes an aqueous-based electrolyte with a zinc-based electroactive material and a lithium-based electroactive material.

### Background

Lithium (Li)-ion batteries (LIB) have been widely used to store energy and power up electronic devices in modern society. In order to increase the energy density or efficiency of the LIB, metallic Li anodes have been focused in the research field due to their high specific capacity and low redox potential. However, there are some disadvantages which impede the practical application of metallic Li anodes in rechargeable batteries, such as (1) safety issue: recently, liquid electrolyte with highly flammable and reactive salts and solvents, for example, carbonates and ethers, are widely used in Li metal batteries, which causes great safety concerns such as risk of volatile organic vapor release, fire and explosion; (2) Lithium dendrite formation: Li metal with high reactivity would react with the solvents and Li salts in these electrolytes to form a passive solid electrolyte interface (SEI) on the anode surface. Usually, the mechanical strength of SEI cannot withstand the volume change during the repeated Li plating-stripping process, leading to generate cracks on the SEI. Then, the Li ion would diffuse to these cracks where the local current density is concentrated and lead to initiate the Li dendrite growth. The Li dendrite can penetrate through the separator and create serious problems such as short circuits and thermal runaway.

Therefore, there is a need in the art to provide an improved rechargeable battery system with high safety and efficiency. More specifically, the improved rechargeable battery system would suppress the corrosion and gas leakage at the electrodes and provide a non-volatile and non-flammable electrolyte. Such an improved rechargeable battery system could be used to make thin, flexible, bendable, and separator-free batteries. In addition, this system could also be adopted in the convention format of rechargeable battery with separator.

### SUMMARY OF THE INVENTION

In view of the foregoing problem, this disclosure provides a rechargeable lithium metal oxide-zinc battery system with an aqueous-based electrolyte.

Accordingly, one aspect of the present invention provides a rechargeable lithium metal oxide-zinc battery system with an aqueous-based electrolyte, which includes at least one positive electrode with a lithium compound, at least one negative electrode with zinc or a zinc compound, an aqueous-based electrolyte, and an aqueous-based solvent. The aqueous-based electrolyte includes at least one zinc-based electroactive material and at least one lithium-based electroactive material. The combination of the electrodes and electrolyte composition suppresses electrode corrosion and gas generation at the negative electrode.

In one embodiment of the present invention, the negative electrode includes zinc or a zinc compound, wherein the zinc compound is selected from a metallic zinc foil or a coated film, and wherein the coated film comprises at least one zinc metallic powder or a zinc alloy metallic powder in an amount of approximately 80 to 95 weight percentage, at least one conductive carbon in an amount of approximately 2 to 10 weight percentage and at least one binder in an amount of approximately 3 to 10 weight percentage.

In another embodiment of the present invention, the positive electrode includes a lithium compound selected from a coated film, wherein the coated film comprises at least one lithium transition metal oxide material in an amount of approximately 85 to 95 weight percentage, at least one conductive carbon in an amount of approximately 2 to 7 weight percentage and at least one binder in an amount of approximately 3 to 8 weight percentage, and wherein the lithium transition metal oxide material is selected from the group consisting of lithium manganese oxide (LMO), lithium cobalt oxide (LCO), lithium nickel manganese cobalt oxide (NMC), and lithium iron phosphate (LFP).

In at least one of the embodiments of the present invention, the at least one zinc-based electroactive material is selected from zinc chloride, zinc nitrate, zinc acetate, zinc perchlorate, zinc sulphate, zinc triflate or zinc bis(trifluoromethanesulfonyl)imide, which is in an amount of approximately 0.5 to 5 M (moles/litre).

In at least one of the embodiments of the present invention, the at least one lithium-based electroactive material is selected from lithium chloride, lithium nitrate, lithium perchlorate, lithium sulphate, lithium triflate or lithium bis(trifluoromethanesulfonyl)imide, which is in an amount of approximately 0.5 to 3 M (moles/litre).

In at least one of the embodiments of the present invention, the solvent is selected from one or more of water and polar solvents, wherein the water is in an amount of approximately 25 to 100 mol percentage, and wherein the polar solvent in an amount of approximately 0 to 75 mol percentage is selected from one or more of solvent capable of hydrogen bonding and/or solvent incapable of hydrogen bonding.

In at least one of the embodiments of the present invention, the solvent capable of hydrogen bonding is selected from ethanol, ethylene glycol, propylene glycol, polyethylene glycol, ethanolamine, diethanolamine, ethylenediamine, 1-butyl-3-methylimidazolium hydrogen sulphate, or deep eutectic solvents.

In at least one of the embodiments of the present invention, the solvent incapable of hydrogen bonding is selected from acetonitrile, succinonitrile, propylene carbonate, or ethylene carbonate.

In at least one of the embodiments of the present invention, the deep eutectic solvent is selected from lithium bis(trifluoromethanesulfonyl)imide (LiTFSI)/urea mixture, LiTFSI/succinonitrile mixture, choline chloride/ethylene glycol mixture, and choline chloride/zinc chloride mixture.

In at least one of the embodiments of the present invention, the aqueous-based electrolyte further comprises a viscosity regulator in an amount of approximately 5 to 30 weight percentage, a monomer solution in an amount of approximately 5 to 15 weight percentage and a photoinitiator in an amount of typically 1 percent of the monomer used.

In at least one of the embodiments of the present invention, the viscosity regulator is selected from poly(diallyldimethylammonium chloride), polyethylene oxide, polyvinyl alcohol, Poly(vinylidene fluoride-co-hexafluoropropylene), polyvinylpyrrolidone and polyethylene glycol, or any combination thereof.

In at least one of the embodiments of the present invention, the monomer solution is selected from poly(ethylene glycol) diacrylate, acrylic acid, trimethylolpropane ethoxylate triacrylate, trimethylolpropane triacrylate, hydroxyethyl acrylate, poly (ethylene glycol) methyl ether acrylate, or any combination thereof.

In at least one of the embodiments of the present invention, the photoinitiator is selected from 2-Methyl-4′-(methylthio)2-morpholinopropiophenone, 4,4′Bis(dimethylamino)benzophenone, 2-Hydroxy-2-methylpropiophenone, Benzophenone, 2-Benzyl-2-(dimethylamino)-4′-morpholinobutyrophnone and 4-hydroxybenzophenone, or any combination thereof.

In at least one of the embodiments of the present invention, the aqueous-based electrolyte is non-volatile and non-flammable.

A rechargeable battery comprising at least one separator and the lithium metal oxide-zinc battery system of the present invention is also provided, wherein the rechargeable battery has a sealed pouch cell format.

Another aspect of the present invention provides a rechargeable battery with an aqueous-based electrolyte, which includes at least one positive electrode, at least one negative electrode, and an aqueous-based electrolyte. The aqueous-based electrolyte includes at least one zinc-based electroactive material in an amount of approximately 0.5 to 5 M (moles/litre), at least one lithium-based electroactive material in an amount of approximately 0.5 to 3 M (moles/litre), and a solvent selected from one or more of water and polar solvents. The combination of the electrodes and electrolyte composition suppresses electrode corrosion and gas generation at the negative electrode.

### BRIEF DESCRIPTION OF THE DRAWINGS

The disclosure will become more fully understood from the detailed description given herein below for illustration only, and thus not limitative of the disclosure, wherein:

FIG. 1 illustrates a rechargeable battery with the aqueous-based electrolyte in the pouch cell format.

FIG. 2 illustrates the process for preparing a rechargeable battery with a UV-cured gel polymer as a separator.

FIG. 3 illustrates charge-discharge performance of a pouch battery obtained from Example 1.

FIG. 4 illustrates charge-discharge performance of a pouch battery obtained from Example 2.

### DEFINITIONS

The terms “a” or “an” are used to include one or more than one and the term “or” is used to refer to a nonexclusive “or” unless otherwise indicated. In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

It should be apparent to those skilled in the art that many modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “includes”, “including”, “comprises” and “comprising” should be interpreted as referring to elements, components, or steps in a non-exclusive manner, indicating that the referenced elements, components, or steps may be present, or utilized, or combined with other elements, components, or steps that are not expressly referenced.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a concentration range of “about 0.1% to about 5%” should be interpreted to include not only the explicitly recited concentration of about 0.1 wt. % to about 5 wt. %, but also the individual concentrations (e.g., 1%, 2%, 3%, and 4%) and the sub-ranges (e.g., 0.1% to 0.5%, 1.1% to 2.2%, and 3.3% to 4.4%) within the indicated range.

### DETAILED DESCRIPTION

The present invention will be described in detail through the following embodiments with appending drawings. It should be understood that the specific embodiments are provided for an illustrative purpose only, and should not be interpreted in a limiting manner.

The present invention provides a rechargeable lithium metal oxide-zinc battery system with an aqueous-based electrolyte. The rechargeable lithium metal oxide-zinc battery system includes at least one positive electrode, at least one negative electrode, an aqueous-based electrolyte and an aqueous-based solvent. According to some embodiments of the present invention, the negative electrode includes zinc or a zinc compound and the zinc compound is selected from, for example, not limited to a metallic zinc foil or a coated film; the positive electrode includes a lithium compound and the lithium compound is selected from, for example, not limited to a coated film; the aqueous-based electrolyte further comprises at least one zinc-based electroactive material and at least one lithium-based electroactive material.

In one embodiment, the coated film of the negative electrode further comprises at least one zinc metallic powder or a zinc alloy metallic powder, at least one conductive carbon and at least one binder. The amount of the zinc metallic powder or the zinc alloy metallic powder is approximately 80 to 95 weight percentage, the amount of the conductive carbon is approximately 2 to 10 weight percentage and the amount of the binder is approximately 3 to 10 weight percentage. Examples of conductive carbon include, but not limited to, graphite, carbon black, carbon nanotubes and graphene. Examples of binder include, but not limited to, carboxymethylcellulose-styrenebutadiene rubber (CMC-SBR), sodium alginate and phenoxy resin.

In one embodiment, the coated film of the positive electrode further comprises at least one lithium transition metal oxide material, at least one conductive carbon and at least one binder. The amount of the lithium transition metal oxide material is approximately 85 to 95 weight percentage, the amount of the conductive carbon is approximately 2 to 7 weight percentage and the amount of the binder is approximately 3 to 8 weight percentage. In some embodiments, the lithium transition metal oxide material is selected from, for example, but not limited to the group consisting of lithium manganese oxide (LMO), lithium cobalt oxide (LCO), lithium nickel manganese cobalt oxide (NMC), and lithium iron phosphate (LFP). Examples of conductive carbon include, but not limited to, graphite, carbon black, carbon nanotubes and graphene. Examples of binder include, but not limited to, carboxymethylcellulose-styrenebutadiene rubber (CMC-SBR), sodium alginate and phenoxy resin.

The reaction at the negative electrode during the charging process is the reduction of zinc ion to form a zinc metal, and then the zinc metal is oxidized to form zinc ion during the discharging process. The reaction at the zinc negative electrode is presented as below equation:

Zn²⁺+2e⁻↔Zn

Meanwhile, the reaction at the positive electrode during the charging process is the oxidation of the lithium metal oxide where the lithium ions are released simultaneously from the lithium metal oxide, and then during discharging process, a reduction takes place on the lithium metal oxide simultaneously as lithium ions are intercalated into the lithium metal oxide. The reaction at the lithium metal oxide positive electrode is presented as below equation:

Li₁₋ₓMOx+xLi⁺+xe⁻↔LiMOx

The electrons involved in these oxidation/reduction reactions provide the current through the external circuit. More specifically, an oxidation reaction at the negative electrode produces positively charged zinc ions and negatively charged electrons during the discharge; after the transportation of electrons through an external circuit to the positive electrode, electrons would combine with the lithium ions to form the lithium metal compound at the positive electrode. During charging process, these reactions and transportation take place in the opposite direction. The external circuit provides electric energy to initiate the charging process, where electrons move from the positive electrode to the negative electrode and the energy is stored as chemical energy in the cell.

Rechargeable batteries supply energy by converting chemical energy into electricity and regain the energy in reverse actions. Usually, the electrolytes used in rechargeable batteries are classified into two categories: liquid electrolyte and solid electrolyte. In the present invention, the electrolyte is an aqueous-based electrolyte, which includes at least one zinc-based electroactive material and at least one lithium-based electroactive material providing the required ionic conductivity of the electrolyte. In some embodiments, the zinc-based electroactive material is selected from, for example, but not limited to zinc chloride, zinc nitrate, zinc acetate, zinc perchlorate, zinc sulphate, zinc triflate or zinc bis(trifluoromethanesulfonyl)imide. The amount of the zinc-based electroactive material is approximately from 0.5 to 5 M (moles/litre). Furthermore, the lithium-based electroactive material is selected from, for example, but not limited to lithium chloride, lithium nitrate, lithium perchlorate, lithium sulphate, lithium triflate or lithium bis(trifluoromethanesulfonyl)imide. The amount of lithium-based electroactive material is approximately from 0.5 to 3 M (moles/litre). The use of combinations of electroactive materials promote a balanced electrochemical property of the electrolyte in terms of ionic conductivity, pH, gas generation and electrode corrosion suppression.

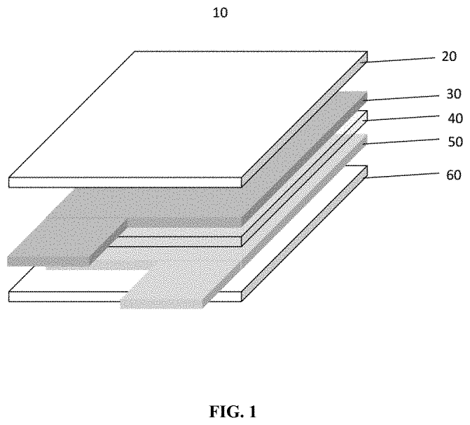

The aqueous-based electrolyte in the present invention is able to adopt into thin and flexible rechargeable batteries. In various embodiment, the aqueous-based electrolyte is utilized in batteries with pouch format, and the design of the aqueous-based electrolyte in the present invention ensures that no gas is generated during the charging/discharging cycles (FIG. 1). Referring to FIG. 1, the pouch battery 10 includes a top package portion 20, a negative electrode 30, a separator 40, a positive electrode 50, a bottom package portion 60, and an aqueous-based electrolyte 70. The aqueous-based electrolyte 70 is filled in the space in the pouch battery 10. The package portions 20 and 60 may be any packaging material, preferably one that is moisture proof and optionally heat-sealable. Further, printing technology is also applied to form the negative/positive electrodes, the manufacturing process is simplified since some steps in conventional electrode manufacturing are eliminated. In addition, printing technology enables flexible layer design for the battery so as to integrate easily with printed electronic devices as their power source. Various printing techniques may be used to form the negative/positive electrodes. These include, for example, but not limit to screen printing, stencil printing, inkjet printing or doctor blade techniques.

In some embodiments of the present invention, the electroactive materials of the aqueous-based electrolyte are dispersed or dispensed in solvents thoroughly and the aqueous-based electrolyte is able to flow freely inside the battery. The solvents are selected from one or more of water and polar solvents. The polar solvents are selected from one or more of solvents capable of hydrogen bonding and solvents incapable of hydrogen bonding. In addition, the amount of water is approximately from 25 to 100 mol percentage and the amount of the polar solvent is approximately from 0 to 75 mol percentage. Table 1 shows the exemplary solvents of the polar solvents described herein. As for the deep eutectic solvents in solvents capable of hydrogen bonding, the deep eutectic solvents are selected from, for example, but not limited to lithium bis(trifluoromethanesulfonyl)imide (LiTFSI)/urea mixture, LiTFSI/succinonitrile mixture, choline chloride/ethylene glycol mixture, and choline chloride/zinc chloride mixture

TABLE 1
exemplary solvents of the polar solvents in the aqueous-based electrolyte.

| Polar solvents | Exemplary solvents |
|---|---|
| solvents capable of | ethanol, ethylene glycol, propylene glycol, |
| hydrogen bonding | polyethylene glycol, ethanolamine, |
| | diethanolamine, ethylenediamine, |
| | 1-butyl-3-methylimidazolium hydrogen sulphate, |
| | or deep eutectic solvents |
| solvents incapable of | acetonitrile, succinonitrile, |
| hydrogen bonding | propylene carbonate, or ethylene |
| | carbonate. |

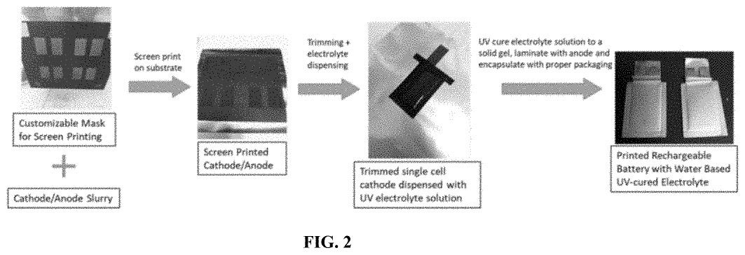

In various embodiments, the aqueous-based electrolyte can be formulated for separator free application which further includes a viscosity regulator, a monomer solution, and a photoinitiator. The photoinitiator would facilitate the UV-curing of the monomer so as to form a stable structure of gel-like polymer, which not only functions as a carrier of charge but also has sufficient mechanical strength to function as a separator and prevents contact between the positive and negative electrode of the battery. More specifically, after UV or visible light irradiation, a water-insoluble polymeric network is formed to trap or enclose the electroactive material in a gel-like structure such that there is no free-flowing liquid inside the battery package. The process of preparing a rechargeable battery with a UV-cured gel polymer as a separator is illustrated in FIG. 2.

In some embodiments, the viscosity regulator of the aqueous-based electrolyte is selected from, for example, but not limited to poly(diallyldimethylammonium chloride), polyethylene oxide, polyvinyl alcohol, Poly(vinylidene fluoride-co-hexafluoropropylene), polyvinylpyrrolidone and polyethylene glycol or mixtures thereof. The amount of viscosity regulator is approximately 5 to 30 weight percentage. The monomer solution of the aqueous-based electrolyte is selected from one or more of poly(ethylene glycol) diacrylate, acrylic acid, trimethylolpropane ethoxylate triacrylate, trimethylolpropane triacrylate, hydroxyethyl acrylate, poly (ethylene glycol) methyl ether acrylate or mixtures thereof and the amount of monomer solution is approximately 5 to 15 weight percentage. Further, the photoinitiator of the aqueous-based electrolyte is selected from, for example, but not limited to 2-Methyl-4′-(methylthio)2-morpholinopropiophenone, 4,4′Bis(dimethylamino)benzophenone, 2-Hydroxy-2-methylpropiophenone, Benzophenone, 2-Benzyl-2-(dimethylamino)-4′-morpholinobutyrophnone and 4-hydroxybenzophenone or mixtures thereof, and the amount of photoinitiator is approximately 1 percent of the monomer being used.

### EXAMPLES

### Example 1: Liquid Electrolyte for Pouch Cell

Preparation of Liquid Electrolyte for Gas Suppression on Zinc:

1. In this example, the combination of water and a deep eutectic solvent is used as the electrolyte solvent.
2. The deep eutectic solvent is first prepared by mixing lithium bis(trifluoromethanesulfonyl)imide (LiTFSI) and succinonitrile.
3. Zinc triflate is first mixed with water as the wetting of zinc triflate is easier with water.
4. The deep eutectic solvent is mixed into the zinc triflate-water mixture. The final mixture is stirred at 60° C. until a clear homogeneous mixture is obtained, typically requiring 1 to 2 hours for the stirring.
5. For the deep eutectic solvent, the weight ratio of LiTFSI to succinonitrile typically ranges between 1:1.2 to 1:3. The concentration of Zn ions is typically between 0.5 M to 1.2 M, and the amount of water utilized as solvent is typically between 25 to 50 mol. %.
6. A sealed pouch cell using a combination of a LMO cathode and a Zn foil anode with an example aqueous electrolyte using approximately 30 mol. % water as the solvent together with a deep eutectic solvent using LiTFSI/succinonitrile at weight ratio of 1:1.35, and containing 0.8 M Zn ion was stored in a 60° C. and for at least 1 month, no gassing was detected. As a comparison, when an aqueous electrolyte is used with only water as the solvent, gassing will occur after a storage period of 2 to 4 weeks in room condition, and gassing occurs after less than 1 week if stored in temperature above 40° C.

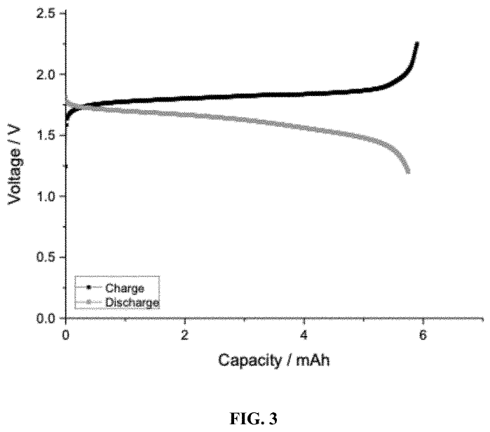

The pouch cell uses a separator and a non-gassing electrolyte even at high temperature. The charge-discharge performance of the pouch cell with liquid electrolyte is shown in FIG. 3, which shows the charge-discharge profiles at different rate in the voltage range of 1.0 to 2.5 V. The results show that the present pouch cell has stable charge and discharge performance.

### Example 2: Separator Free Application to Form the UV Cured Gel Electrolyte which is the Intermediate Layer of Battery

1. In this example, a 20% solution of poly(diallyldimethylammonium chloride) (PDDA) in water purchased from Sigma-Aldrich is used.
2. To the PDDA-water solution, ZnCl₂ and LiCl are added and stirred until clear.
3. Afterwards, PEGDA is added and stirred until clear.
4. The photo-initiator is added at a ratio of 1:100 of PEGDA. The mixture is stirred for 5 minutes and ready for use. This is the solution of the intermediate layer.
5. The intermediate layer solution from this preparation procedure typically includes 25% to 40% ZnCl2, 4% to 8% LiCl, 5% to 10% PEGDA and photo-initiator (ratio of PEGDA to photoinitiator 100:1), 40% to 60% water and 8% to 12% PDDA.
6. This intermediate layer solution after curing with UV for more than approximately 30 seconds forms a solid gel.
Typically, the intermediate layer solution is dispensed on the surface of a coated electrode, as an example, on the surface of a cathode LMO. Afterwards, the intermediate layer solution is UV cured to form a solid gel on top of the LMO cathode, and onto which an anode which is a Zn foil or a coated Zn film is laminated to form the final battery structure.

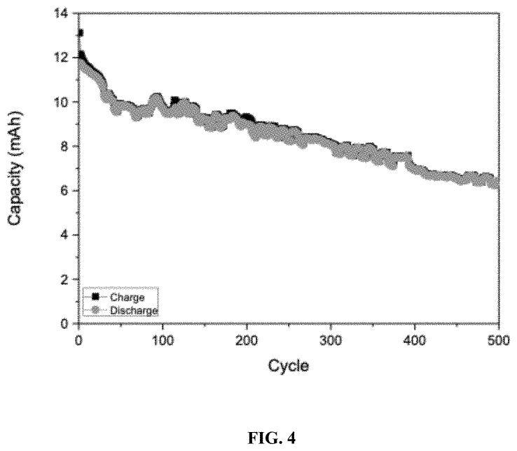

The final battery structure is separator-free, which uses a UV-cured gel polymer electrolyte. Referring to FIG. 4, the charge-discharge performance of the separator-free pouch cell is tested. It can be seen that when the battery is charged and discharged for 500 cycles, the battery capacity remains at least 55% of the original capacity.

1. A rechargeable lithium metal oxide-zinc battery system with an aqueous-based electrolyte, comprising:
at least one positive electrode including a lithium compound;
at least one negative electrode including zinc or a zinc compound;
an aqueous-based electrolyte comprising:
at least one zinc-based electroactive material;
at least one lithium-based electroactive material;
an aqueous-based solvent;
wherein a combination of the electrodes and electrolyte composition suppresses electrode corrosion and gas generation at the negative electrode.

2. The rechargeable lithium metal oxide-zinc battery system of claim 1, wherein the negative electrode including zinc or a zinc compound is selected from a metallic zinc foil or a coated film, wherein the coated film comprises at least one zinc metallic powder or a zinc alloy metallic powder in an amount of approximately 80 to 95 weight percentage, at least one conductive carbon in an amount of approximately 2 to 10 weight percentage and at least one binder in an amount of approximately 3 to 10 weight percentage.

3. The rechargeable lithium metal oxide-zinc battery system of claim 1, wherein the positive electrode including a lithium compound is a coated film, the coated film comprising at least one lithium transition metal oxide material in an amount of approximately 85 to 95 weight percentage, at least one conductive carbon in an amount of approximately 2 to 7 weight percentage and at least one binder in an amount of approximately 3 to 8 weight percentage; wherein the lithium transition metal oxide material is selected from the group consisting of lithium manganese oxide (LMO), lithium cobalt oxide (LCO), lithium nickel manganese cobalt oxide (NMC), and lithium iron phosphate (LFP).

4. The rechargeable lithium metal oxide-zinc battery system of claim 1, wherein the zinc-based electroactive material in an amount of approximately 0.5 to 5 M (moles/litre) is selected from zinc chloride, zinc nitrate, zinc acetate, zinc perchlorate, zinc sulphate, zinc triflate or zinc bis(trifluoromethanesulfonyl)imide.

5. The rechargeable lithium metal oxide-zinc battery system of claim 1, wherein the lithium-based electroactive material in an amount of approximately 0.5 to 3 M (moles/litre) is selected from lithium chloride, lithium nitrate, lithium perchlorate, lithium sulphate, lithium triflate or lithium bis(trifluoromethanesulfonyl)imide.

6. The rechargeable lithium metal oxide-zinc battery system of claim 1, wherein the solvent is selected from one or more of water and polar solvents; wherein water is in an amount of approximately 25 to 100 mol percentage; wherein the polar solvent in an amount of approximately 0 to 75 mol percentage is selected from one or more of solvents capable of hydrogen bonding, solvents incapable of hydrogen bonding.

7. The rechargeable lithium metal oxide-zinc battery system of claim 6, wherein the polar solvent is selected from one or more of solvents capable of hydrogen bonding, or solvents incapable of hydrogen bonding.

8. The rechargeable lithium metal oxide-zinc battery system of claim 7, wherein the solvent capable of hydrogen bonding is selected from ethanol, ethylene glycol, propylene glycol, polyethylene glycol, ethanolamine, diethanolamine, ethylenediamine, 1-butyl-3-methylimidazolium hydrogen sulphate, or deep eutectic solvents.

9. The rechargeable lithium metal oxide-zinc battery system of claim 7, wherein the solvent incapable of hydrogen bonding is selected from acetonitrile, succinonitrile, propylene carbonate, or ethylene carbonate.

10. The rechargeable lithium metal oxide-zinc battery system of claim 8, wherein the deep eutectic solvent is selected from lithium bis(trifluoromethanesulfonyl)imide (LiTFSI)/urea mixture, LiTFSI/succinonitrile mixture, choline chloride/ethylene glycol mixture, and choline chloride/zinc chloride mixture.

11. The rechargeable lithium metal oxide-zinc battery system of claim 1, wherein the aqueous-based electrolyte further comprises a viscosity regulator in an amount of approximately 5 to 30 weight percentage, a monomer solution in an amount of approximately 5 to 15 weight percentage and a photoinitiator in an amount of typically 1 percent of the monomer used.

12. The rechargeable lithium metal oxide-zinc battery system of claim 11, wherein the viscosity regulator is selected from poly(diallyldimethylammonium chloride), polyethylene oxide, polyvinyl alcohol, Poly(vinylidene fluoride-co-hexafluoropropylene), polyvinylpyrrolidone and polyethylene glycol or mixtures thereof.

13. The rechargeable lithium metal oxide-zinc battery system of claim 11, wherein the monomer solution is selected from poly(ethylene glycol) diacrylate, acrylic acid, trimethylolpropane ethoxylate triacrylate, trimethylolpropane triacrylate, hydroxyethyl acrylate, poly (ethylene glycol) methyl ether acrylate or mixtures thereof.

14. The rechargeable lithium metal oxide-zinc battery system of claim 11, wherein the photoinitiator is selected from 2-Methyl-4′-(methylthio)2-morpholinopropiophenone, 4,4′Bis(dimethylamino)benzophenone, 2-Hydroxy-2-methylpropiophenone, Benzophenone, 2-Benzyl-2-(dimethylamino)-4′-morpholinobutyrophnone and 4-hydroxybenzophenone or mixtures thereof.

15. The rechargeable lithium metal oxide-zinc battery system of claim 1, wherein the aqueous-based electrolyte is non-volatile and non-flammable.

16. A rechargeable battery comprising at least one separator and the lithium metal oxide-zinc battery system of claim 1.

17. The rechargeable battery of claim 16, wherein the battery has a sealed pouch cell format.
